(19) United States
(12) Patent Application Publication
(10) Pub. No.: US 2026/0080691 A1
(43) Pub. Date: Mar. 19, 2026

(54) DETECTION OF LANE AND ROAD BOUNDARIES

(71) Applicant: QUALCOMM Incorporated, San Diego, CA (US)

(72) Inventors: Saeed Dabbaghchian, Bromma (SE); Mohammadreza Malek-Mohammadi, Solna (SE); Behnaz Rezaei, San Diego, CA (US); Senthil Kumar Yogamani, San Diego, CA (US)

(21) Appl. No.: 18/888,992

(22) Filed: Sep. 18, 2024

(51) Int. Cl. G06V 20/56; G06V 10/44; G06V 10/762

(52) U.S. Cl. CPC G06V 20/588; G06V 10/44; G06V 10/762

(57) ABSTRACT

A computing system may determine, for a plurality of polylines associated with one or more pictures of a video, a plurality of pair-wise distance measures for pairs of polylines from the plurality of polylines. The computing system may cluster, based on the plurality of pair-wise distance measures, a subset of polylines from the plurality of polylines to generate a polyline cluster. The computing system may determine a lane boundary or a road boundary that corresponds to the polyline cluster and may output information indicative of the lane boundary or the road boundary.

### TECHNICAL FIELD

This disclosure relates to autonomous vehicles and vehicles including advanced driver-assistance systems (ADAS).

### BACKGROUND

An autonomous driving vehicle is a vehicle that is configured to sense the environment around the vehicle, such as the existence and location of other objects, and operating without human control. The autonomous driving vehicle may include sensors such as cameras, a light detection and ranging (LiDAR) system, and/or other sensor system, to sense the environment around the vehicle. In operation, the autonomous driving vehicle may perform operations such as object detection, lane and road boundary detection, safety analysis, drivable free-space analysis, control generation during vehicle maneuvers, and/or other operations. The autonomous driving vehicle may include an Advanced Driver Assistance System (ADAS) that uses sensors and software to assist a driver in operating the vehicle, such as to the vehicle avoid hazardous situations to ensure safety and reliability.

### SUMMARY

In general, this disclosure describes techniques for detecting road and lane boundaries in an environment. Detecting road and lane boundaries in autonomous driving and/or assisted driving (e.g., ADAS) applications may enable vehicles to safely navigate roads. Road and lane boundary detection may also be useful for generating high definition (HD) maps, which are detailed representations of road environments used by autonomous vehicles and ADASs for precise navigation and decision-making.

A vehicle that carries an array of sensors, such as cameras, a LiDAR system, and the like, may capture data that about the road environment around the vehicle. A system may identify, in the road environment, features that are indicative of road and lane boundaries, and may fit polylines to the identified features.

The system may compute, for the polylines, pair-wise distance measures for pairs of polylines. A pair-wise distance measure for a pair of polylines may take into account a measure of similarity between the pair of polylines, the curvature difference between the pair of polylines, and/or the perpendicular distance between the pair of polylines. The system may perform clustering of the polylines based on the pair-wise distance measures to determine one or more road and lane boundaries in the road environment around the vehicle. For example, the system may cluster a subset of the generated polylines based on the pair-wise distance measures and may fit a new polyline over the clustered subset of polylines as a road or lane boundary.

In some aspects, the techniques described herein relate to a method including: determining, for a plurality of polylines associated with one or more pictures of a video, a plurality of pair-wise distance measures for pairs of polylines from the plurality of polylines; clustering, based on the plurality of pair-wise distance measures, a subset of polylines from the plurality of polylines to generate a polyline cluster; determining a lane boundary or a road boundary that corresponds to the polyline cluster; and outputting information indicative of the lane boundary or the road boundary.

In some aspects, the techniques described herein relate to a computing system including: one or more memories; and processing circuitry implemented in circuitry, coupled to the one or more memories, and configured to: determine, for a plurality of polylines associated with one or more pictures of a video, a plurality of pair-wise distance measures for pairs of polylines from the plurality of polylines; cluster, based on the plurality of pair-wise distance measures, a subset of polylines from the plurality of polylines to generate a polyline cluster; determine a lane boundary or a road boundary that corresponds to the polyline cluster; and output information indicative of the lane boundary or the road boundary.

In some aspects, the techniques described herein relate to a computer-readable storage medium storing instructions thereon that when executed cause processing circuitry to: determine, for a plurality of polylines associated with one or more pictures of a video, a plurality of pair-wise distance measures for pairs of polylines from the plurality of polylines; cluster, based on the plurality of pair-wise distance measures, a subset of polylines from the plurality of polylines to generate a polyline cluster; and determine a lane boundary or a road boundary that corresponds to the polyline cluster.

In some aspects, the techniques described herein relate to an apparatus including: means for determining, for a plurality of polylines associated with one or more pictures of a video, a plurality of pair-wise distance measures for pairs of polylines from the plurality of polylines; means for clustering, based on the plurality of pair-wise distance measures, a subset of polylines from the plurality of polylines to generate a polyline cluster; means for determining a lane boundary or a road boundary that corresponds to the polyline cluster; and means for outputting information indicative of the lane boundary or the road boundary.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system in accordance with one to more techniques of this disclosure.

FIG. 2 is a block diagram illustrating example vehicle systems according to one or more aspects of this disclosure.

FIG. 3 is a conceptual diagram illustrating example results of using pair-wise distance measures to determine road and lane boundaries, according to the techniques of the present disclosure.

FIG. 4 is a flowchart showing an example method of operation according to the techniques of this disclosure.

### DETAILED DESCRIPTION

In general, this disclosure describes techniques for detecting road and lane boundaries in an environment. Detecting road and lane boundaries in autonomous driving and/or assisted driving (e.g., ADAS) applications may enable vehicles to safely navigate roads. For example, detecting road and lane boundaries may enable a vehicle to stay within its lane and may enable the vehicle to safely perform maneuvers such as lane changes and turns. Further, road and lane boundary detection may also be useful for generating high definition (HD) maps, which are detailed representations of road environments used by autonomous vehicles and ADASs for precise navigation and decision-making.

A vehicle that carries an array of sensors, such as one or more cameras, a LiDAR system, a radar system, and the like, may continuously capture data about the road environment around the vehicle as the vehicle is being driven. For example, the one or more cameras may continually record video of the surrounding environment, and the LiDAR system may continuously emit light pulses and sense the light pulses reflected off of objects in the surrounding environment.

Such a vehicle that continuously capture data about the road environment around the vehicle may be an autonomous driving vehicle or a vehicle having an ADAS that captures data about the surrounding environment. In another example, such a vehicle may be operating to map the surrounding environment of the vehicle for the purposes of generating HD maps used by autonomous vehicles and ADASs for precise navigation and decision-making.

A system, such as an autonomous driving system, an ADAS, or an external system may use the captured data to detect road and lane boundaries in the road environment around the vehicle. The system may identify, from the captured data, features in the road environment such as curbs, lane markings, road edges, other navigational markers, and the like that are indicative of road and lane boundaries. For example, the system may synthesize the video captured by one or more cameras of the vehicle's sensor system with other sensor data captured by the vehicle's sensor's system to identify, in each picture of the video, features in the road environment that are indicative of road and lane boundaries.

Unlike object detection, road and lane boundaries may be continuous and may extend through multiple frames of video, and therefore may not be captured by simple bounding boxes. Instead, the system may, for each picture (e.g., image frame) of the video, fit polylines to the features identified as being indicative of road and lane markers. A polyline is a connected series of line segments that connect consecutive points, also referred to as vertices, in the polyline. That is, each polyline may include two or more points and one or more straight lines that connect a sequence of points of the polyline. In some examples, a polyline is also referred to as a simple polygonal chain.

The system may, for each feature identified as being indicative of road and lane marker in a picture of a video, fit a polyline to the feature by generating a polyline that represents the detected feature's shape and location in the picture. That is, the system may generate, for a feature, a polyline that approximates the shape and location of the feature in the picture. The system may fit a polyline to a feature in ways that minimize the difference between the polyline and the feature, such as by minimizing the distances between detected points of the feature to the nearest point to the polyline.

The system may determine road and lane boundaries based on the polylines fitted to the feature identified as being indicative of road and lane markers. Some techniques for determining road boundaries and lane boundaries include clustering points of polylines in a single picture into one or more clusters based on Euclidian distance and associating each of the clusters with a road or lane boundary. For example, the system may fit a polyline to each cluster of points and may determine the resulting polyline to be a road or lane boundary.

A real-world environment may provide various challenges to determining road boundaries and lane boundaries. For example, features of road and lane boundaries such as lane markers may be occluded due to low lighting or shadows, or may have faded due to age. Sensors such as cameras, a light detection and ranging (LiDAR) system for capturing data such as images and light pulses may also introduce noise in the captured data, which may cause errors in determining road and lane boundaries. Real-world roads and streets may also have features, such as stray paint, debris, and the like, that may be mistaken for a lane marker. As such, a system that generates polylines based on data captured by cameras and/or LiDAR systems may sometimes fail to generate polylines for certain lane markers or may sometimes generate outlier polylines, which are polylines that do not represent a portion of an actual road or lane boundary.

Further, real-world features of roads and streets may have complex topologies that provide various challenges to determining road boundaries and lane boundaries. For example, road lanes may have curves instead of being perfectly straight. Further, lanes of a road may include forks, in which one lane forks into multiple lanes, and/or joins, in which multiple lanes join into a single lane.

As described above, techniques for determining road boundaries and lane boundaries may include naively clustering points of polylines in a single picture into one or more clusters based on Euclidian distance and associating each of the clusters with a road or lane boundary. However, such naïve clustering of points of polylines may be extremely sensitive to outlier polylines, as a single outlier polyline may cause such techniques to merge two distinct clusters of polylines indicative of two separate road or lane boundaries into a single road or lane boundary. Further, such techniques may not be able to properly delineate lane boundaries where a lane has forked into two or more lanes.

In accordance with aspects of this disclosure, a system may determine road and/or lane boundaries based on polylines with increased accuracy compared with existing techniques. The system may, for a plurality of polylines determined from one or more pictures (e.g., image frames) of video, determine pair-wise distance measures for each of a plurality of pairs of polylines. The pair-wise distance measure for each pair of polylines may be based on (e.g., take into account) the similarity of the polylines, the curvature difference of the polylines, and the perpendicular distance between the polylines. The system may cluster a subset of the plurality of polylines based on the pair-wise distance measures for the pairs of polylines to generate a polyline cluster and may determine a road boundary or a lane boundary that corresponds to the polyline cluster. For example, the system may, for each polyline cluster, fit a polyline to the polylines in the polyline cluster, and may determine that the fitted polyline is a road or lane boundary.

A pair-wise distance measure based on the similarity of the polylines may enable the system to distinguish between outlier polylines and non-outlier polylines, and may decrease the likelihood that the system clusters outlier polylines with non-outlier polylines. Further, a pair-wise distance measure based on the curvature difference of the polylines may also enable the system to better delineate lane boundaries for lanes having forks and/or joins. In addition, a pair-wise distance measure based on the perpendicular distance between the polylines may enable the system to distinguish between lane boundaries that are very close to each other, such as double lane markings. As such, the techniques of this disclosure may enable a system to more accurately detect road and lane boundaries in an environment compared with existing techniques, thereby providing a technical advantage.

The techniques of this disclosure may also enable a system to predict and/or cluster road and lane boundaries across time. That is, the system may obtain polylines extracted from multiple consecutive pictures of video and may cluster polylines from the multiple pictures into one or more clusters based on the pair-wise distance measures. The system may therefore be able to associate polylines from multiple consecutive pictures of video as being part of the same road or lane boundary. In this way, the techniques of this disclosure may provide further technical advantages over existing techniques that determines road and lane boundaries for discrete pictures of a video.

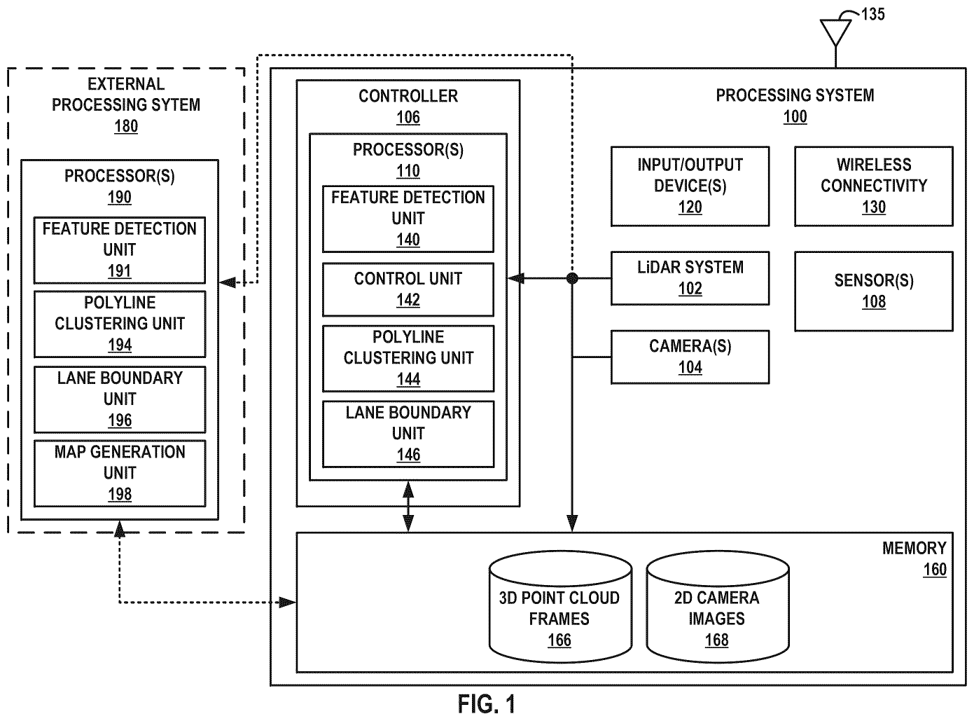

FIG. 1 is a block diagram illustrating an example processing system in accordance with one to more techniques of this disclosure. Processing system 100 may be used in a vehicle, such as an autonomous driving vehicle or an assisted driving vehicle (e.g., a vehicle having an ADAS or an “ego vehicle”). In such an example, processing system 100 may represent an ADAS. In some examples, the techniques of this disclosure may be applied by any system that processes image data.

Processing system 100 may include LiDAR system 102, camera(s) 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames based on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera(s) 104. The color attribute includes color values (e.g., red, green, and blue (RGB)) values for each point. The color values may be used to improve visualization and aid in enhanced classification (e.g., the color information can aid in the classification of objects and features in the scene, such as vegetation, buildings, and roads). In some examples, color values may be indicative of an edge or boundary between two objects and/or features, such as between a building and a sidewalk.

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may include any type of camera configured to capture video or image data in the environment around processing system 100 (e.g., around a vehicle). In some examples, processing system 100 may a single camera 104. In other examples, processing system 100 may include multiple camera(s) 104. For example, camera(s) 104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 104 may be a color camera or a grayscale camera. In some examples, camera(s) 104 may be a camera system including more than one camera sensor. While techniques of this disclosure may be described with reference to a two-dimensional (2D) photographic camera and a LiDAR system, the techniques of this disclosure may be applied to the outputs of other sensors that capture information, including a sonar sensor, a radar sensor, an infrared camera, and/or a time-of-flight (ToF) camera.

LiDAR system 102 may, in some examples, be configured to collect 3D point cloud frames 166. Camera(s) 104 may, in some examples, be configured to collect 2D camera images 168, which may be a series of pictures (e.g., image frames) making up a video that is captured by camera(s) 104.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input/output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processor(s) 110. Controller 106 is not limited to controlling vehicles. Controller 106 may additionally or alternatively control any kind of controllable device, such as a robotic component. Processor(s) 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processor(s) 110 may be loaded, for example, from memory 160 and may cause processor(s) 110 to perform the operations attributed to processor(s) in this disclosure.

An NPU is generally a specialized circuit configured for implementing control and arithmetic logic for executing machine learning algorithms, such as algorithms for processing artificial neural networks (ANNs), DNNs, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may be configured to accelerate the performance of common machine learning tasks, such as image classification, machine translation, object detection, and various other tasks. In some examples, a plurality of processor(s) 110 may be instantiated on a single chip, such as a system on a chip (SoC), while in other examples one or more of processor(s) 110 may be part of a dedicated machine learning accelerator device.

In some examples, one or more of processor(s) 110 may be optimized for training or inference, or in some cases configured to balance performance between both. For processor(s) 110 that are capable of performing both training and inference, the two tasks may still generally be performed independently.

In some examples, processor(s) 110 designed to accelerate training are generally configured to accelerate the optimization of new models, which is a highly compute-intensive operation that involves inputting an existing dataset (often labeled or tagged), iterating over the dataset, and then model parameters, such as weights and biases, in order to improve model performance. Generally, optimizing based on a wrong prediction involves propagating back through the layers of the model and determining gradients to reduce the prediction error. In some examples, some or all of the adjustment of model parameters may be performed outside of processing system 100, such as in external processing system 180.

In some examples, processor(s) 110 designed to accelerate inference are generally configured to operate on complete models. Such processor(s) 110 may thus be configured to input a new piece of data and rapidly process the data through an already trained model to generate a model output (e.g., an inference).

In some examples, processor(s) 110 may operate on predictive models such as artificial neural networks (ANNs) or random forests (RFs). An ANN may include a hardware and/or a software component that includes a number of connected nodes (e.g., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge may be associated with one or more node weights that determine how the signal is processed and transmitted. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A DNN is a class of neural network that is commonly used in computer vision or image classification systems. A DNN may include the use of multiple layers. One type of DNN may be a convolutional neural network (CNN). In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Processor(s) 110 may also include one or more sensor processing units associated with LiDAR system 102, camera(s) 104, and/or sensor(s) 108. For example, processor(s) 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. Sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include one or more memories, such as random access memory (RAM), read-only memory (ROM), electrically erasable programmable ROM (EEPROM), compact disk ROM (CD-ROM), and/or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells of memory 160. For example, the memory controller can include a row decoder, column decoder, or both. In some cases, memory cells within memory 160 store information in the form of a logical state.

Processing system 100 may be configured to perform techniques for extracting features from 2D camera images 168 and 3D point cloud frames 166, processing the features, fusing the features, or any combination thereof. For example, processor(s) 110 may include feature detection unit 140. Feature detection unit 140 may be implemented in software, firmware, and/or any combination of hardware described herein. Feature detection unit 140 may be configured to obtain 2D image data, such as 2D camera images 168, and/or 3D point cloud data, such as 3D point cloud frames 166. For example, feature detection unit 140 may be configured to receive 2D camera images 168 and/or 3D point cloud frames 166 directly from camera(s) 104 and LiDAR system 102, respectively, or from memory 160. In some examples, such 2D camera images 168 may be pictures captured by camera(s) 104 that have been transformed, such as into a bird's eye viewpoint perspective.

Feature detection unit 140 may be configured to determine a plurality of polylines from the 2D camera images 168 and/or 3D point cloud frames 166. Processor(s) 110 is configured to execute feature detection unit 140 to identify, from camera images 168, features in the road environment, such as curbs, lane markings, road edges, other navigational markers, and the like, that are indicative of road and lane boundaries. For example, feature detection unit 140 may synthesize camera images 168 captured by camera(s) 104 with 3D point cloud frames 166 sensed by LiDAR system 102 captured to identify, in each picture of camera images 168, features in the road environment that are indicative of road and lane boundaries.

Feature detection unit 140 may perform any suitable technique to identify, from camera images 168, features that are indicative of road and lane boundaries. For example, feature detection unit 140 may perform image processing techniques such as edge detection, color segmentation, and the like. In some examples, feature detection unit 140 may include or use a neural network, such as a convolutional neural network or a transformer-based network, that is trained via machine learning to identify features that are indicative of road and lane boundaries and to output polylines that are fitted to the identified features.

Processor(s) 110 is configured to execute feature detection unit 140 to, for each picture of camera images 168, fit polylines to the features identified as being indicative of road and lane markers. Feature detection unit 140 may, for each feature identified as being indicative of road and lane marker in a picture, fit a polyline to the feature by generating a polyline that represents the detected feature's shape and location in the picture. That is, feature detection unit 140 may generate, for a feature, a polyline that approximates the shape and location of the feature in the picture. For example, feature detection unit 140 may determine a series of points in the picture that corresponds to the feature and may connect the series of points with line segments to fit the polyline to the feature. Feature detection unit 140 may, in some examples, fit a polyline to a feature in ways that minimize the difference between the polyline and the feature, such as by minimizing the distances between detected points of the feature to the nearest point to the polyline.

In some examples, if the system detects, in a picture, a lane marker in the form of a series of broken lines (e.g., dashed lines), feature detection unit 140 may fit a polyline to each broken line of the series of broken lines, where each polyline approximates the shape and location of one of the broken lines in the picture. In another example, if feature detection unit 140 detects, in a picture, a lane marker that is a solid curved line, feature detection unit 140 may fit a polyline to the solid curved line that approximates the shape and location of the solid curved line in the picture.

Each polyline fitted to an identified feature in a picture may therefore include a sequence of two or more points, each having (x, y) coordinates, and one or more straight lines that connect the consecutive points of the polyline. By fitting polylines to features in camera images 168 that are identified as being indicative of road and lane markers, feature detection unit 140 may determine a plurality of polylines from camera images 168.

Feature detection unit 140 may generate polylines in a local coordinate system or a global coordinate system. That is, the (x, y) coordinates of points of polylines may be in reference to a local coordinate system or a global coordinate system. A local coordinate system, in some examples, may be a coordinate system that is defined with respect to processing system 100. In some examples, feature detection unit 140 may generate polylines in a local coordinate system, and another unit of processor(s) 110, such as polyline clustering unit 144, may transform the polylines into a global coordinate system, such as via use of an inertial navigation system (INS) sensor.

In accordance with aspects of this disclosure, processing system 100 may be configured to perform techniques for clustering polylines determined from camera images 168 into one or more polyline clusters. For example, processor(s) 110 may include polyline clustering unit 144. Polyline clustering unit 144 may be implemented in software, firmware, and/or any combination of hardware described herein.

Processor(s) 110 may be configured to execute polyline clustering unit 144 to determine, for a plurality of polylines determined from one or more pictures (e.g., camera images 168) of a video, a plurality of pair-wise distance measures for pairs of polylines from the plurality of polylines. In some examples, the pairs of polylines from the plurality of polylines may include every unique pair of two different polylines from the plurality of polylines. The plurality of polylines may include polylines extracted from one or more images frames of video. In some examples, the plurality of polylines may include polylines extracted from a single picture, or may include a plurality of polylines extracted from a current picture of the video and a plurality of polylines extracted from one or more previous frames of the video. As described above, each polyline in the plurality of polylines may include one or more straight lines that connect a sequence of points, and each polyline may have the same or different number of points. For example, a first polyline may have two straight lines that connect a sequence of three points, a second polyline may have seven straight lines that connect a sequence of eight points, and so on.

A pair-wise distance measure for a pair of polylines, which may be any two different polylines from the plurality of polylines, may be a measure of distance between two polylines making up the pair of polylines and may be represented as a numerical value. In some examples, to determine the plurality of pair-wise distance measures for pairs of polylines from the plurality of polylines, polyline clustering unit 144 may, for each pair of polylines from the plurality of polylines, determine a corresponding pair-wise distance measure for the pair of polylines.

Processor(s) 110 may be configured to execute polyline clustering unit 144 to determine, for each of a plurality of pairs of polylines from the plurality of polylines, the corresponding pair-wise distance measure that is a function of a measure of similarity between a corresponding pair of polylines, the difference in curvature between the respective curvatures of corresponding pair of polylines, and/or a distance in a normal direction between the corresponding pair of polylines.

Polyline clustering unit 144 may determine a measure of similarity between a pair of polylines as the Hausdorff distance between the pair of polylines. In mathematics, a Hausdorff distance is a measure of how far two subsets of a metric space are from each other. That is, two sets may be close in the Hausdorff distance if every point of either set is close to some point of the other set. In some examples, the Hausdorff distance between a pair of polylines may be approximate as or set equal to the greatest of all the distances from a point in one polyline to the closest point in the other polyline. Determining the Hausdorff distance between a pair of polylines may be useful to prevent clustering of outlier polylines with non-outlier polylines, as the Hausdorff distance between an outlier polyline and a non-outlier polyline may be relatively large compared with the Hausdorff distance between two non-outlier polylines.

As another example of Hausdorff distance, given a plurality of polylines, Pᵢ=[P_{i,1}, P_{i,2}, . . . , P_{i,n}_{ᵢ}] may denote the i-th polylines with nᵢ points, where polylines in the plurality of polylines do not necessarily have the same number of points per polyline. The Hausdorff distance H(Pᵢ,Pⱼ) between a pair of polylines Pᵢ and Pⱼ may be defined as

$$H ( {P}_{i} , {P}_{j} ) = max \{ {sup}_{p ∈ {P}_{i}} d ( p , {P}_{j} ) , {sup}_{{p}^{′} ∈ {P}_{j}} d ( {p}^{′} , {P}_{i} ) \} d ( p , P ) = {inf}_{q ∈ P} d ( p , q ) .$$

where d is an Euclidean distance, where sup is the supremum operator, and where inf is the infimum operator.

Polyline clustering unit 144 may determine the difference in curvature between a pair of polylines by fitting a curve to each of the two polylines and determining the curvature difference between the two curves fitted to the two polylines. Because two polylines having similar curvatures may be more likely to be part of the same road or lane boundary, including the curvature difference between the pair of polylines in the per-pair distance measure may be useful for determining whether to cluster the pair of polylines.

In some examples, Polyline clustering unit 144 may fit a clothoid curvature to each of the two polylines and determining the difference in curvature between the pair of polylines as the curvature difference between the clothoid curvatures of the two polylines. Fitting clothoid curvatures to the two polylines may be well suited for determining road and lane boundaries because the curves of many roads may follow the clothoid curve. For example, for a pair of polylines Pᵢ, and Pⱼ, let Cᵢ and Cⱼ denote the curvature of the clothoids fit to Pᵢ and Pⱼ, respectively. The curvature difference C(Pᵢ,Pⱼ) between a pair of polylines Pᵢ, and Pⱼ can therefore be expressed as C=|Cᵢ−Cⱼ|.

Polyline clustering unit 144 may determine the distance in a normal direction between a pair of polylines, which is also referred to as the perpendicular distance between the pair of polylines. Processor(s) 110 may determine the polyline distance in a normal direction N(Pᵢ,Pⱼ) between a pair of polylines Pᵢ, and Pⱼ, which may be expressed as

$$N ( {P}_{i} , {P}_{j} ) = max \{ {sup}_{p ∈ {P}_{i}} {d}_{n} ( p , {P}_{j} ) , {sup}_{{p}^{′} ∈ {P}_{j}} {d}_{n} ( {p}^{′} , {P}_{i} ) \} ,$$

where dₙ is a perpendicular distance.

Determining the perpendicular distance between the pair of polylines may aid in distinguishing between lane markers, such as double lane markers, that are very close in distance from each other but are part of different road or lane boundaries. By determining the perpendicular distance between a pair of polylines, polyline clustering unit 144 may be able to distinguish between lane markers that are very close in distance from each other but are part of different road or lane boundaries.

In some examples, polyline clustering unit 144 may determine the pair-wise distance measure for a pair of polylines as a weighted sum of the Hausdorff distance between the pair of polylines, the curvature difference between the pair of polylines, and the polyline distance in a normal direction between the pair of polylines. In these examples, the pair-wise distance measure dist(Pᵢ,Pⱼ) for a pair of polylines Pᵢ and Pⱼ may be expressed as dist (Pᵢ,Pⱼ)=w_{H}H(Pᵢ,Pⱼ)+w_{C}C(Pᵢ,Pⱼ)+w_{N}N(Pᵢ,Pⱼ), where w_{H}, w_{C}, w_{N} are weights that adjust the contribution of each term to the pair-wise distance measure. Each of the weights may have a value that is between 0.0 and 1.0. In some examples, processor(s) 110 may adjust the weights to more heavily weigh the contributions of the Hausdorff distance and the distance in the normal direction compared to the contribution of the curvature difference, and/or may more heavily weigh the contribution of the Hausdorff distance compared to the contribution of the distance in the normal direction.

Processor(s) 110 may be configured to execute polyline clustering unit 144 to cluster, based on the plurality of pair-wise distance measures, a subset of polylines from the plurality of polylines to generate a polyline cluster that includes the clustered subset of polylines. That is, polyline clustering unit 144 may be able to cluster one or more subsets of polylines from the plurality of clusters into one or more polyline clusters. For example, polyline clustering unit 144 may cluster the plurality of polylines into two or more polyline clusters, where each polyline cluster contains a unique subset of polylines from the plurality of polylines. In some examples, polyline clustering unit 144 may cluster polylines from the same picture into two or more polyline clusters.

In general, polyline clustering unit 144 may cluster two polylines if the pair-wise distance metric for the two polylines is below a specified distance threshold. In some examples, polyline clustering unit 144 may use density-based spatial clustering of applications with noise (DBSCAN) to cluster the subset of polylines as the lane boundary or the road boundary.

Processing system 100 may be configured to perform techniques for determining, for each polyline cluster, a road or lane boundary that correspond to the polyline cluster. For example, processor(s) 110 may include lane boundary unit 146. Lane boundary unit 146 may be implemented in software, firmware, and/or any combination of hardware described herein.

Processor(s) 110 may be configured to execute lane boundary unit 146 to determine, for each of one or more polyline clusters determined by polyline clustering unit 144, a corresponding road or lane boundary in the environment captured by camera images 168. For example, lane boundary unit 146 may, for each polyline cluster in a picture, fit a polyline to the polylines in the polyline cluster and determine that the generated polyline is a corresponding road boundary or lane boundary.

In some examples, if a polyline cluster includes polylines from multiple pictures of video, lane boundary unit 146 may determine that the polyline cluster corresponds to a road boundary or lane boundary that continues through the multiple pictures. For example, if a polyline cluster includes polylines from a current picture of video and includes polylines from one or more previous frames of the video, lane boundary unit 146 may determine that the polylines from multiple frames of the video corresponds to a road boundary or lane boundary that continues through the multiple frames of video. Further if lane boundary unit 146 has previously determined that the polylines from the one or more previous frames of the video forms a particular road boundary or lane boundary, lane boundary unit 146 may determine that the polylines in the same polyline cluster from a current picture of video may be a continuation of the particular road boundary or lane boundary that corresponds to the other polylines in the same polycule in the previous frames of the video.

In some examples, lane boundary unit 146 may use the Hungarian algorithm, also referred to as the Hungarian method, to associate polylines across multiple pictures to determine a road boundary or a lane boundary corresponding to the polylines across multiple pictures. The Hungarian algorithm is a combinatorial optimization algorithm for the association between the sets. The complexity of performing the Hungarian algorithm is n², where n is the number of polylines.

To reduce the complexity of performing the Hungarian algorithm, lane boundary unit 146 may, for a polyline cluster (e.g., determined by polyline clustering unit 144) that spans multiple pictures, reduce the number of polylines in a polyline cluster that are in each picture. For example, lane boundary unit 146 may, for each picture having two or more polylines in the same polyline cluster, fit a polyline to the two or more polylines in the picture that belongs to the same polyline cluster. Lane boundary unit 146 may therefore replace the two or more polylines in the polyline cluster with the fitted polyline.

By fitting a polyline to all polylines in a picture that belongs to the same polyline cluster, lane boundary unit 146 reduces the number of polylines in a polyline cluster, thereby reducing the complexity of performing the Hungarian algorithm. In this way, lane boundary unit 146 reduces usage of processor(s) 110 to perform the Hungarian algorithm. Lane boundary unit 146 may therefore use the Hungarian algorithm to associate the polylines in a polyline cluster across multiple pictures to determine a road boundary or a lane boundary corresponding to the polylines that continues through the multiple pictures.

Lane boundary unit 146 may output information indicative of the road boundaries and/or lane boundaries determined by lane boundary unit 146. For example, lane boundary unit 146 may output, such as to control unit 142, one or more polylines, where each polyline corresponds to a lane boundary or a road boundary determined from the plurality of polylines.

Processor(s) 110 may also include control unit 142. Control unit 142 may be implemented in software, firmware, and/or any combination of hardware described herein. Processor(s) 110 may execute control unit 142 to control operation of a vehicle based on information indicative of the road boundaries and/or lane boundaries determined by lane boundary unit 146. For example, control unit 142 may control operations of the vehicle to maintain the position of the vehicle within its lane and/or to enable the vehicle to safely perform maneuvers such as lane changes and turns.

Generally, processing system 100 and/or components thereof may be configured to perform the techniques described herein. Processing system 100 of FIG. 1 is just one example, and in other examples, alternative processing system 100 with more, fewer, and/or different components may be used.

In some examples, an external processing system 180 may be configured to perform the techniques described herein with respect to processing system 100. For example, external processing system 100 may perform the techniques described herein to generate or update high definition (HD) maps, which are detailed representations of road environments used by autonomous vehicles and ADASs for precise navigation and decision-making.

External processing system 180 be implemented as any suitable external computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, external processing system 180 may represent a cloud computing system, server farm, and/or server cluster (or portion thereof) that provides services to client devices and other devices or systems. In other examples, external processing system 180 may represent or be implemented through one or more virtualized compute instances (e.g., virtual machines, containers, etc.) of a data center, cloud computing system, server farm, and/or server cluster.

External processing system 180 may include one or more processor(s) 190. Processor(s) 190 may be similar to processor(s) 110 described above. External processing system 180 may include feature detection unit 191, which may be similar to feature detection unit 140, polyline clustering unit 194, which may be similar to polyline clustering unit 144, lane boundary unit 196, which may be similar to lane boundary unit 146, and map generation unit 198. Each of feature detection unit 191, polyline clustering unit 194, lane boundary unit 196, and map generation unit 198 may be implemented in software, firmware, and/or any combination of hardware described herein.

Processor(s) 190 may be configured to execute feature detection unit 191 to obtain 2D image data, such as frames of videos captured by camera(s) 104 of processing system 100 and/or 3D point cloud frames 166, such as 3D point cloud frames generated by LiDAR system 102 of processing system 100 and to determine a plurality of polylines from the 2D camera images and/or 3D point cloud frames. For example, processor(s) 190 may execute feature detection unit 191 to perform techniques similar to those performed by feature detection unit 140 to determine, for a plurality of pictures of video, a plurality of polylines that represent features identified as being indicative of road and lane markers in the pictures of the video.

Processor(s) 190 may be configured to execute polyline clustering unit 194 to perform clustering of the polylines (e.g., the polylines determined by feature detection unit 191) into one or more polyline clusters. For example, processor(s) 190 may execute polyline clustering unit 194 to perform techniques similar to those performed by polyline clustering unit 144 to determine pair-wise distance measures for a plurality of pairs of polylines and to cluster the polylines into one or more polyline clusters based on the pair-wise distance measures.

Processor(s) 190 may be configured to execute lane boundary unit 196 to determine road or lane boundaries associated with the one or more polyline clusters generated by polyline clustering unit 194. For example, processor(s) 190 may execute lane boundary unit 196 to perform techniques similar to those performed by lane boundary unit 146 to determine road or lane boundaries associated with the one or more polyline clusters. Lane boundary unit 196 may output information indicative of the road boundaries and/or lane boundaries determined by lane boundary unit 196. For example, lane boundary unit 196 may output, such as to map generation unit 198, one or more polylines, where each polyline corresponds to a lane boundary or a road boundary determined from the plurality of polylines.

Processor(s) 190 may be configured to execute map generation unit 198 to create or update a HD map based on the road or lane boundaries determined by lane boundary unit 196. For example, map generation unit 198 may use the information indicative of the road or lane boundaries, such as outputted by lane boundary unit 196, along with positional data regarding the locations of those road or lane boundaries to generate or to update a HD map to include such road or lane boundaries.

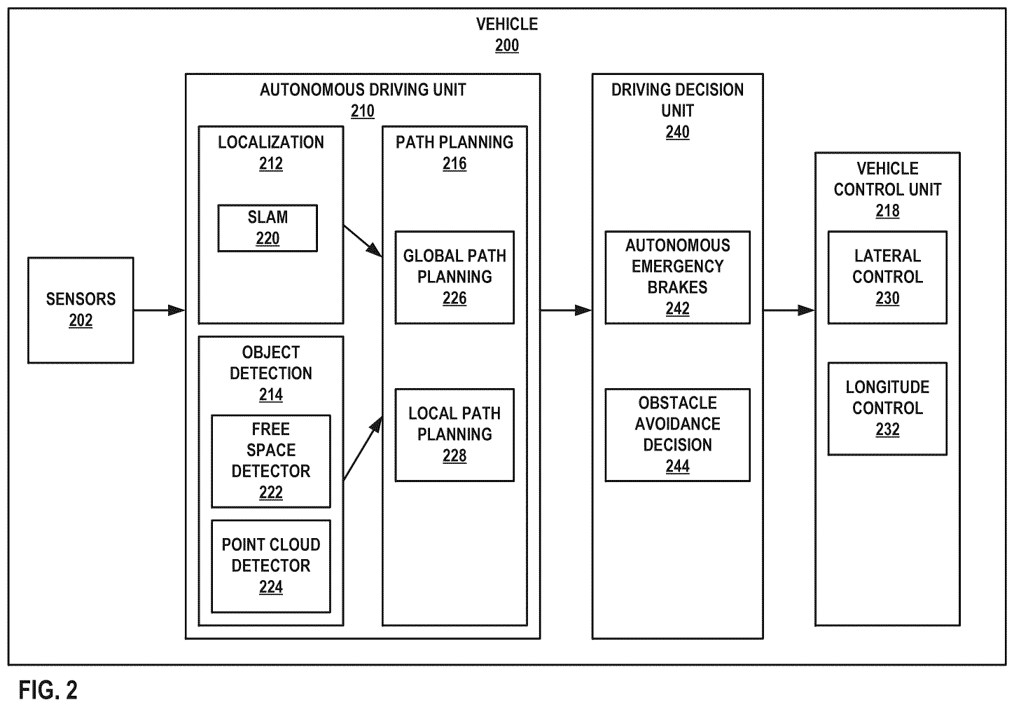

FIG. 2 is a block diagram illustrating example vehicle systems according to one or more aspects of this disclosure. Vehicle 200 may include processing system 100 of FIG. 1, which may form all of, or part of, any combination of units described with respect to FIG. 2.

Vehicle 200 may include sensors 202, autonomous driving unit 210, driving decision unit 240, and vehicle control unit 218. Sensors 202 may include LiDAR sensor(s) similar to LiDAR system 102 and camera sensor(s) similar to camera(s) 104 of FIG. 1. Sensors 202 may include radar sensors, global positioning satellite (GPS) sensors, and/or the like, which may be similar to sensors of sensor(s) 108 of FIG. 1. Autonomous driving unit 210 may include localization unit 212, object detection unit 214, path planning unit 216, and vehicle control unit 218. A number of units within autonomous driving unit 210 may operate based on input from sensors 202. For example, localization unit 212 and object detection unit 214 may utilize information from sensors 202.

Localization unit 212 may include simultaneous localization and mapping (SLAM) unit 220. SLAM unit 220 may determine a globally consistent representation of the environment around vehicle 200, for example, based on input data from sensors 202. For example, SLAM unit 220 may implement or otherwise perform the functionalities of feature detection unit 140, polyline clustering unit 144, and lane boundary unit 146 of FIG. 1 to detect and predict road and lane boundaries based on sensor data received from sensors 202. In another example, SLAM unit 220 may use a HD map, such as generated and/or updated by external processing system 180 of FIG. 1, to determine a globally consistent representation of the environment around vehicle 200.

Object detection unit 214 may include free space detector 222 and point cloud detector 224 which may be used to detect objects within an environment surrounding vehicle 200. Free space detector 222 may estimate or detect free space in the surrounding environment. Point cloud detector 224 may generate a point cloud based on, for example, LiDAR and/or radar data.

Path planning unit 216 may include global path planning unit 226 and local path planning unit 228. Global path planning unit 226 may plan a path based on an assumption of a static environment around vehicle 200 for example, including roads, sidewalks, buildings, and the like. Local path planning unit 228 may plan a path based on dynamic information such as sensor data indicative of changes in the environment around vehicle 200, or based on a HD map, such as generated and/or updated by external processing system 180 of FIG. 1. As path planning unit 216 determines the path which vehicle 200 may travel, it may be desirable to have accurate data input to path planning unit 216, such as data output by free space detector 222.

Driving decision unit 240 may be configured to make decisions about how vehicle 200 should respond based on output of the path planning unit 216. Driving decision unit 240 may include autonomous emergency brakes unit 242 and/or obstacle avoidance decision unit 244. Autonomous emergency brakes unit 242 may be configured to determine whether or not to apply emergency brakes of vehicle 200 to avoid a collision. Obstacle avoidance decision unit 244 may be configured to determine how to avoid an obstacle.

Vehicle control unit 218, which may be similar to control unit 142 of FIG. 1, may include lateral control unit 230 and longitude control unit 232. Lateral control unit 230 may be configured to, based on the output of driving decision unit 240, control the lateral direction of the maneuvering of vehicle 200. For example, lateral control unit 230 may control steering of vehicle 200 in one direction or another direction to avoid an obstacle or otherwise navigate vehicle 200. Longitude control unit 232 may be configured to control the longitudinal direction of the maneuvering of vehicle 200 via vehicle control unit 218. For example, longitude control unit 232 may control a throttle system and/or braking system to accelerate or apply brakes for vehicle 200.

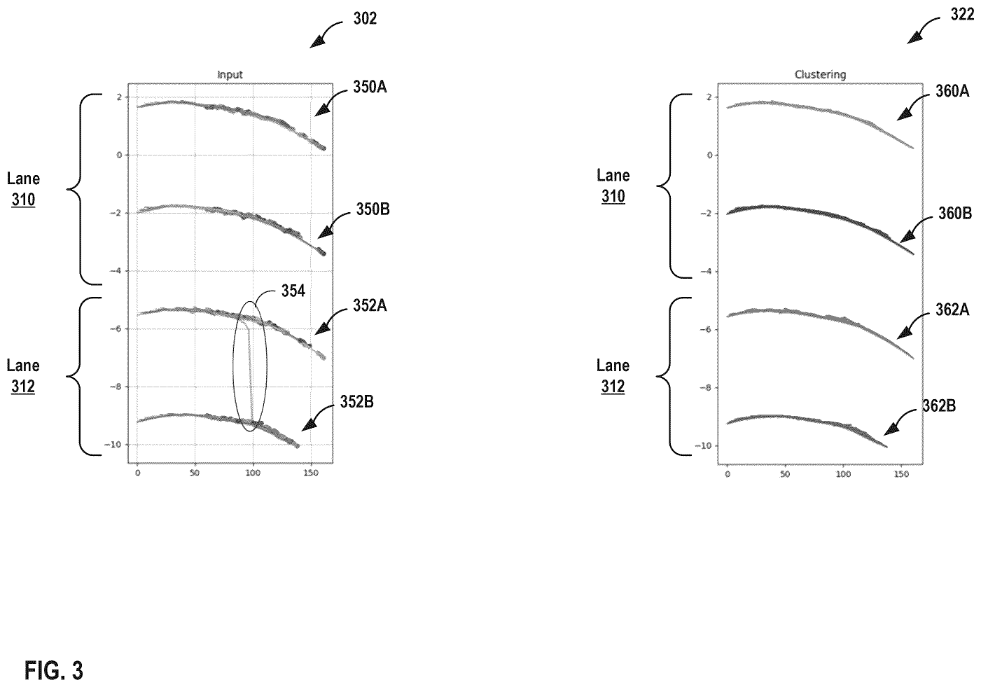

FIG. 3 is a conceptual diagram illustrating example results of using pair-wise distance measures to determine road and lane boundaries, according to the techniques of the present disclosure. As shown in FIG. 3, chart 302 illustrates naïve fitting a lane boundary to raw polylines while chart 322 illustrates clustering of polylines using pair-wise distance measures, as performed by polyline clustering unit 144 of FIG. 1.

For example, feature detection unit 140 of FIG. 1 may determine, for a lane of road, denoted in this example as lane 310, a plurality of polylines that are indicative of lane markers for lane 310. Lane boundaries 350A and 350B of chart 302 illustrates the opposing lane boundaries for lane 310 determined by naively fitting lane boundaries to polylines for lane 310, while lane boundaries 360A and 360B of chart 322 illustrates the opposing lane boundaries for lane 310 determined by clustering the polylines for lane 310 based on pair-wise distance measures for pairs of the polylines. Because the polylines for lane 310 does not include any outlier polylines, naively fitting lane boundaries to polylines may perform almost as well as clustering based on pair-wise distance measures for the purposes of detecting lane boundaries.

However, when a plurality of polylines include one or more outlier polylines, which are polylines that do not represent a portion of an actual road or lane boundary, naïve fitting of lane boundaries to polylines may fail to correctly determine lane boundaries based on the polylines. For example, feature detection unit 140 of FIG. 1 may determine, for another lane of road, denoted in this example as lane 312, a plurality of polylines that are indicative of lane markers for lane 312. In this example, the polylines determined for lane 312 may include an outlier polyline, which may be a polyline fitted to a feature that is not a lane marker for lane 312.

Lane boundaries 352A and 352B of chart 302 illustrates the opposing lane boundaries for lane 312 determined by naively clustering of points of the polylines for lane 312. As can be seen, the outlier polyline may cause such a naïve fitting of lane boundaries 352A and 352B to the polylines to incorrectly determine that lane boundary 352A is connected to lane boundary 352B at location 354.

Meanwhile, lane boundaries 362A and 362B of chart 322 illustrates the opposing lane boundaries for lane 312 determined by clustering the polylines for lane 312 based on pair-wise distance measures for pairs of the polylines. Because pair-wise distance measures may take into account a Hausdorff distance between pairs of polylines, applying the techniques described in this disclosure to determine lane boundaries for lane 312 by clustering the polylines for lane 312 based on pair-wise distance measures may ensure that lane boundaries 362A and 362B can be correctly determined for lane 312, even when the polylines determined for lane 312 may include an outlier polyline.

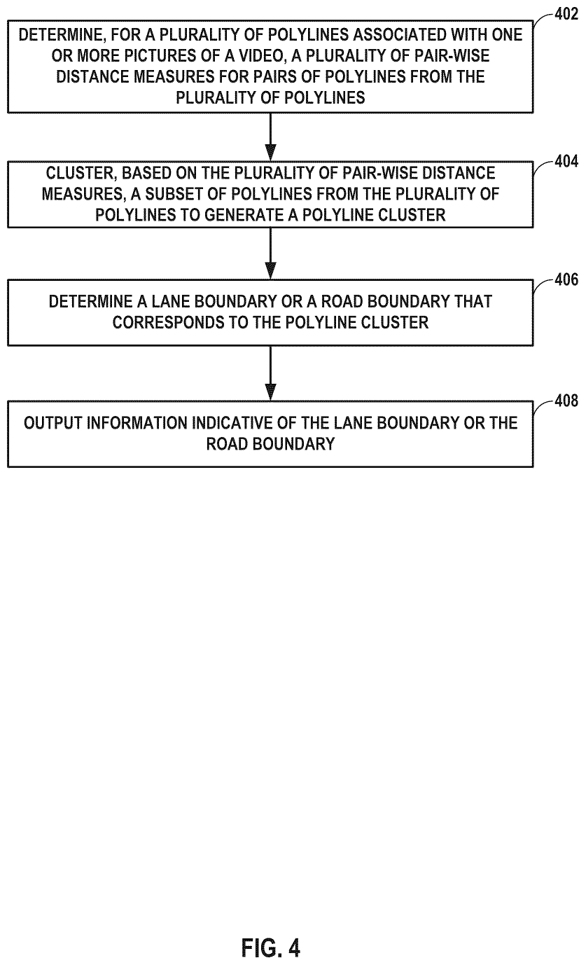

FIG. 4 is a flowchart showing an example method of operation according to the techniques of this disclosure. For case, the example is described with respect to FIG. 1.

As shown in FIG. 4, one or more processors 110 or 190 may determine, for a plurality of polylines associated with one or more pictures of a video, a plurality of pair-wise distance measures for pairs of polylines from the plurality of polylines (402). In some examples, the plurality of polylines are fitted to features identified as being indicative of road and lane markers in the one or more pictures of the video. In some examples, each polyline from the plurality of polylines includes one or more straight lines that connect a sequence of points.

In some examples, to determine the plurality of pair-wise distance measures, one or more processors 110 or 190 may determine, for each of the pairs of polylines from the plurality of polylines, the corresponding pair-wise distance measure as a function of a Hausdorff distance between a corresponding pair of polylines, a curvature difference between the corresponding pair of polylines, and a perpendicular distance between the corresponding pair of polylines. In some examples, one or more processors 110 or 190 may determine, for each of the pairs of polylines, the corresponding pair-wise distance measure as a weighted sum of the Hausdorff distance between the corresponding pair of polylines, the curvature difference between the corresponding pair of polylines, and the perpendicular distance between the corresponding pair of polylines. In some examples, one or more processors 110 or 190 may fit a first clothoid curvature to a first polyline of the corresponding pair of polylines, fit a second clothoid curvature to a second polyline of the corresponding pair of polylines, and determine the curvature difference between the corresponding pair of polylines based on a difference in curvature between the first clothoid curvature and the second clothoid curvature.

One or more processors 110 or 190 may cluster, based on the plurality of pair-wise distance measures, a subset of polylines from the plurality of polylines to generate a polyline cluster (404). In some examples, one or more processors 110 or 190 may cluster, based on the plurality of distance measures and using density-based spatial clustering of applications with noise (DBSCAN), the subset of polylines to generate the polyline cluster.

One or more processors 110 or 190 may determine a lane boundary or a road boundary that corresponds to the polyline cluster (406). In some examples, the one or more pictures of the video includes a current picture and one or more previous pictures, and the subset of polylines includes a first one or more polylines associated with the current picture of the video and a second one or more of polylines associated with the one or more previous pictures of the video. In some examples, the first one or more polylines include a first plurality of polylines, wherein the second one or more polylines include a second plurality of polylines, and to determine the lane boundary or the road boundary that corresponds to the polyline cluster, one or more processors 110 or 190 may fit a first polyline to the first plurality of polylines, fit a second polyline to the second plurality of polylines, and perform a Hungarian algorithm to associate the first polyline with the second polyline to determine the lane boundary or the road boundary that corresponds to the polyline cluster.

One or more processors 110 or 190 may output information indicative of the lane boundary or the road boundary (408). In some examples, one or more processors 190 may update a high definition map based on the information indicative of the lane boundary or the road boundary. In some examples, one or more cameras of a vehicle may capture the video, and one or more processors 110 may control operations of the vehicle based on the information indicative of the lane boundary or the road boundary.

The following describes other example aspects of the disclosure. The techniques of the following aspects may be used separately or in any combination.
Example 1. A method comprising: determining, for a plurality of polylines associated with one or more pictures of a video, a plurality of pair-wise distance measures for pairs of polylines from the plurality of polylines; clustering, based on the plurality of pair-wise distance measures, a subset of polylines from the plurality of polylines to generate a polyline cluster; determining a lane boundary or a road boundary that corresponds to the polyline cluster; and outputting information indicative of the lane boundary or road boundary.
Example 2. The method of example 1, wherein determining the plurality of pair-wise distance measures further comprises: determining, for each of the pairs of polylines from the plurality of polylines, a corresponding pair-wise distance measure as a function of a Hausdorff distance between a corresponding pair of polylines, a curvature difference between the corresponding pair of polylines, and a perpendicular distance between the corresponding pair of polylines.
Example 3. The method of example 2, wherein determining, for each of the pairs of polylines of the plurality of polylines, the corresponding pair-wise distance measure, further comprises: determining, for each of the pairs of polylines, the corresponding pair-wise distance measure as a weighted sum of the Hausdorff distance between the corresponding pair of polylines, the curvature difference between the corresponding pair of polylines, and the perpendicular distance between the corresponding pair of polylines.
Example 4. The method of any of examples 2 and 3, wherein determining the plurality of pair-wise distance measures further comprises: fitting a first clothoid curvature to a first polyline of the corresponding pair of polylines; fitting a second clothoid curvature to a second polyline of the corresponding pair of polylines; and determining the curvature difference between the corresponding pair of polylines based on a difference in curvature between the first clothoid curvature and the second clothoid curvature.
Example 5. The method of any of examples 1-4, wherein clustering the subset of polylines to generate the polyline cluster further comprises: clustering, based on the plurality of pair-wise distance measures and using density-based spatial clustering of applications with noise (DBSCAN), the subset of polylines to generate the polyline cluster.
Example 6. The method of any of examples 1-5, wherein the one or more pictures of the video comprise a current picture of the video and one or more previous pictures of the video, and wherein the subset of polylines includes a first one or more polylines associated with the current picture and a second one or more polylines associated with the one or more previous pictures.
Example 7. The method of example 6, wherein the first one or more polylines include a first plurality of polylines, wherein the second one or more polylines include a second plurality of polylines, and wherein determining the lane boundary or the road boundary that corresponds to the polyline cluster further comprises: fitting a first polyline to the first plurality of polylines; fitting a second polyline to the second plurality of polylines; and performing a Hungarian algorithm to associate the first polyline with the second polyline to determine the lane boundary or the road boundary that corresponds to the polyline cluster.
Example 8. The method of any of examples 1-7, wherein the plurality of polylines are fitted to features identified as being indicative of road and lane markers in the one or more pictures of the video.
Example 9. The method of any of examples 1-8, further comprising: capturing, by one or more cameras of a vehicle, the video; wherein outputting the information indicative of the lane boundary or the road boundary comprises controlling operation of the vehicle based on the lane boundary or the road boundary.
Example 10. The method of any of examples 1-9, wherein each polyline from the plurality of polylines includes one or more straight lines that connect a sequence of points.
Example 11. A computing system comprising: one or more memories; and processing circuitry implemented in circuitry, coupled to the one or more memories, and configured to: determine, for a plurality of polylines associated with one or more pictures of a video, a plurality of pair-wise distance measures for pairs of polylines from the plurality of polylines; cluster, based on the plurality of pair-wise distance measures, a subset of polylines from the plurality of polylines to generate a polyline cluster; determine a lane boundary or a road boundary that corresponds to the polyline cluster; and output information indicative of the lane boundary or the road boundary.
Example 12. The computing system of example 11, wherein to determine the plurality of pair-wise distance measures, the processing circuitry is further configured to: determine, for each of the pairs of polylines from the plurality of polylines, a corresponding pair-wise distance measure as a function of a Hausdorff distance between a corresponding pair of polylines, a curvature difference between the corresponding pair of polylines, and a perpendicular distance between the corresponding pair of polylines.
Example 13. The computing system of example 12, wherein to determine, for each of the pairs of polylines of the plurality of polylines, the corresponding pair-wise distance measure, the processing circuitry is further configured to: determine, for each of the pairs of polylines, the corresponding pair-wise distance measure as a weighted sum of the Hausdorff distance between the corresponding pair of polylines, the curvature difference between the corresponding pair of polylines, and the perpendicular distance between the corresponding pair of polylines.
Example 14. The computing system of any of examples 12 and 13, wherein to determine, for each of the pairs of polylines of the plurality of polylines, the corresponding pair-wise distance measure, the processing circuitry is further configured to: fit a first clothoid curvature to a first polyline of the corresponding pair of polylines; fit a second clothoid curvature to a second polyline of the corresponding pair of polylines; and determine the curvature difference between the corresponding pair of polylines based on a difference in curvature between the first clothoid curvature and the second clothoid curvature.
Example 15. The computing system of any of examples 11-14, wherein to cluster the subset of polylines to generate the polyline cluster, the processing circuitry is further configured to: cluster, based on the plurality of pair-wise distance measures and using density-based spatial clustering of applications with noise (DBSCAN), the subset of polylines to generate the polyline cluster.
Example 16. The computing system of any of examples 11-15, wherein the one or more pictures comprise a current picture of the video and one or more previous pictures of the video, and wherein the subset of polylines includes a first one or more polylines associated with the current picture of the video and a second one or more polylines associated with the one or more previous pictures of the video.
Example 17. The computing system of example 16, wherein the first one or more polylines include a first plurality of polylines, wherein the second one or more polylines include a second plurality of polylines, and wherein to determine the lane boundary or the road boundary that corresponds to the polyline cluster, the processing circuitry is further configured to: fit a first polyline to the first plurality of polylines; fit a second polyline to the second plurality of polylines; and perform a Hungarian algorithm to associate the first polyline with the second polyline to determine the lane boundary or the road boundary that corresponds to the polyline cluster
Example 18. The computing system of any of examples 11-17, wherein the plurality of polylines are fitted to features identified as being indicative of road and lane markers in the one or more pictures of the video.
Example 19. The computing system of any of examples 11-18, wherein the computing system is included in a vehicle that comprises one or more cameras configured to capture the video, and wherein to output the information indicative of the lane boundary or the road boundary, the processing circuitry is further configured to: control operation of the vehicle based on the information indicative of the lane boundary or the road boundary.
Example 20. A computer-readable storage medium storing instructions thereon that when executed cause processing circuitry to: determine, for a plurality of polylines associated with one or more pictures of a video, a plurality of pair-wise distance measures for pairs of polylines from the plurality of polylines; cluster, based on the plurality of pair-wise distance measures, a subset of polylines from the plurality of polylines to generate a polyline cluster; determine a lane boundary or a road boundary that corresponds to the polyline cluster; and output information indicative of the lane boundary or the road boundary.
Example 21. A computer-readable storage medium storing instructions thereon that when executed cause processing circuitry to perform the method of any of claims 1-10.
Example 22. An apparatus comprising means to perform the method of any of claims 1-10.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, for a plurality of polylines associated with one or more pictures of a video, a plurality of pair-wise distance measures for pairs of polylines from the plurality of polylines;
clustering, based on the plurality of pair-wise distance measures, a subset of polylines from the plurality of polylines to generate a polyline cluster;
determining a lane boundary or a road boundary that corresponds to the polyline cluster; and
outputting information indicative of the lane boundary or road boundary.

2. The method of claim 1, wherein determining the plurality of pair-wise distance measures further comprises:
determining, for each of the pairs of polylines from the plurality of polylines, a corresponding pair-wise distance measure as a function of a Hausdorff distance between a corresponding pair of polylines, a curvature difference between the corresponding pair of polylines, and a perpendicular distance between the corresponding pair of polylines.

3. The method of claim 2, wherein determining, for each of the pairs of polylines of the plurality of polylines, the corresponding pair-wise distance measure, further comprises:
determining, for each of the pairs of polylines, the corresponding pair-wise distance measure as a weighted sum of the Hausdorff distance between the corresponding pair of polylines, the curvature difference between the corresponding pair of polylines, and the perpendicular distance between the corresponding pair of polylines.

4. The method of claim 2, wherein determining the plurality of pair-wise distance measures further comprises:
fitting a first clothoid curvature to a first polyline of the corresponding pair of polylines;
fitting a second clothoid curvature to a second polyline of the corresponding pair of polylines; and
determining the curvature difference between the corresponding pair of polylines based on a difference in curvature between the first clothoid curvature and the second clothoid curvature.

5. The method of claim 1, wherein clustering the subset of polylines to generate the polyline cluster further comprises:
clustering, based on the plurality of pair-wise distance measures and using density-based spatial clustering of applications with noise (DBSCAN), the subset of polylines to generate the polyline cluster.

6. The method of claim 1, wherein the one or more pictures of the video comprise a current picture of the video and one or more previous pictures of the video, and wherein the subset of polylines includes a first one or more polylines associated with the current picture and a second one or more polylines associated with the one or more previous pictures.

7. The method of claim 6, wherein the first one or more polylines include a first plurality of polylines, wherein the second one or more polylines include a second plurality of polylines, and wherein determining the lane boundary or the road boundary that corresponds to the polyline cluster further comprises:
fitting a first polyline to the first plurality of polylines;
fitting a second polyline to the second plurality of polylines; and
performing a Hungarian algorithm to associate the first polyline with the second polyline to determine the lane boundary or the road boundary that corresponds to the polyline cluster.

8. The method of claim 1, wherein the plurality of polylines are fitted to features identified as being indicative of road and lane markers in the one or more pictures of the video.

9. The method of claim 1, further comprising:
capturing, by one or more cameras of a vehicle, the video;
wherein outputting the information indicative of the lane boundary or the road boundary comprises controlling operation of the vehicle based on the lane boundary or the road boundary.

10. The method of claim 1, wherein each polyline from the plurality of polylines includes one or more straight lines that connect a sequence of points.

11. A computing system comprising:
one or more memories; and
processing circuitry implemented in circuitry, coupled to the one or more memories, and configured to:
determine, for a plurality of polylines associated with one or more pictures of a video, a plurality of pair-wise distance measures for pairs of polylines from the plurality of polylines;
cluster, based on the plurality of pair-wise distance measures, a subset of polylines from the plurality of polylines to generate a polyline cluster;
determine a lane boundary or a road boundary that corresponds to the polyline cluster; and
output information indicative of the lane boundary or the road boundary.

12. The computing system of claim 11, wherein to determine the plurality of pair-wise distance measures, the processing circuitry is further configured to:
determine, for each of the pairs of polylines from the plurality of polylines, a corresponding pair-wise distance measure as a function of a Hausdorff distance between a corresponding pair of polylines, a curvature difference between the corresponding pair of polylines, and a perpendicular distance between the corresponding pair of polylines.

13. The computing system of claim 12, wherein to determine, for each of the pairs of polylines of the plurality of polylines, the corresponding pair-wise distance measure, the processing circuitry is further configured to:
determine, for each of the pairs of polylines, the corresponding pair-wise distance measure as a weighted sum of the Hausdorff distance between the corresponding pair of polylines, the curvature difference between the corresponding pair of polylines, and the perpendicular distance between the corresponding pair of polylines.

14. The computing system of claim 12, wherein to determine, for each of the pairs of polylines of the plurality of polylines, the corresponding pair-wise distance measure, the processing circuitry is further configured to:
fit a first clothoid curvature to a first polyline of the corresponding pair of polylines;
fit a second clothoid curvature to a second polyline of the corresponding pair of polylines; and
determine the curvature difference between the corresponding pair of polylines based on a difference in curvature between the first clothoid curvature and the second clothoid curvature.

15. The computing system of claim 11, wherein to cluster the subset of polylines to generate the polyline cluster, the processing circuitry is further configured to:
cluster, based on the plurality of pair-wise distance measures and using density-based spatial clustering of applications with noise (DBSCAN), the subset of polylines to generate the polyline cluster.

16. The computing system of claim 11, wherein the one or more pictures comprise a current picture of the video and one or more previous pictures of the video, and wherein the subset of polylines includes a first one or more polylines associated with the current picture of the video and a second one or more polylines associated with the one or more previous pictures of the video.

17. The computing system of claim 16, wherein the first one or more polylines include a first plurality of polylines, wherein the second one or more polylines include a second plurality of polylines, and wherein to determine the lane boundary or the road boundary that corresponds to the polyline cluster, the processing circuitry is further configured to:
fit a first polyline to the first plurality of polylines;
fit a second polyline to the second plurality of polylines; and
perform a Hungarian algorithm to associate the first polyline with the second polyline to determine the lane boundary or the road boundary that corresponds to the polyline cluster.

18. The computing system of claim 11, wherein the plurality of polylines are fitted to features identified as being indicative of road and lane markers in the one or more pictures of the video.

19. The computing system of claim 11, wherein the computing system is included in a vehicle that comprises one or more cameras configured to capture the video, and wherein to output the information indicative of the lane boundary or the road boundary, the processing circuitry is further configured to:
control operation of the vehicle based on the information indicative of the lane boundary or the road boundary.

20. A computer-readable storage medium storing instructions thereon that when executed cause processing circuitry to:
determine, for a plurality of polylines associated with one or more pictures of a video, a plurality of pair-wise distance measures for pairs of polylines from the plurality of polylines;
cluster, based on the plurality of pair-wise distance measures, a subset of polylines from the plurality of polylines to generate a polyline cluster;
determine a lane boundary or a road boundary that corresponds to the polyline cluster; and
output information indicative of the lane boundary or the road boundary.
